(19) United States
(12) Patent Application Publication
(10) Pub. No.: US 2001/0044906 A1
(43) Pub. Date: Nov. 22, 2001

(54) RANDOM VISUAL PATTERNS USED TO OBTAIN SECURED ACCESS

(76) Inventors: DIMITRI KANEVSKY, OSSINING, NY (US); STEPHENS HERMAN MAES, DANBURY, CT (US); WLODEK WLODZIMIERZ ZADROZNY, TARRYTOWN, NY (US)

Correspondence Address: KEVIN M. MASON, RYAN, MASON & LEWIS, LLP, 1300 POST ROAD, SUITE 205, FAIRFIELD, CT, 06430, US

(21) Appl. No.: 09/063,805

(22) Filed: Apr. 21, 1998

(51) Int. Cl. H04L 9/00; G06F 12/14; H04L 9/32; G06F 11/30

(52) U.S. Cl. 713/202

(57) ABSTRACT

To improve authenticity of persons accessing secured locations, information, services, and/or goods, random pictures (images) and/or portions of picture are placed on a document (hard copy—e.g. a check—or computer generated). The person requiring access selects a set of one or more of the images/pictures, e.g. by crossing them out. Often the selected images/picture with be familiar to the user. The document is screened, e.g. by a special access server over a network, to check on whether the subset was correct, i.e., matches a subset of images previously stored and associated with the accessor. This can be combined with printed explicit textual questions related to an owner personal database and several possible answers for each question. For further security, biometrics, e.g. from user handwritten answer prompts, can be added. Similar security provision with random visual images can be used when users interact with computers to get access to some services (without providing hard copy documents).

### FIELD OF THE INVENTION

This invention relates to the field of accessing secured locations, accounts, and/or information using visual patterns. More specifically, the invention relates to presenting known and random visual images to a user that are selected by the user to gain access to secured locations, accounts, and/or information using visual patterns.

### BACKGROUND OF THE INVENTION

A person who requires access to a secured location may either present a hard copy document or interact with an agent via a computer system.

In the hard copy method, a hard copy document, e.g. a check, is presented by a person who requires access to some goods/services. A check includes a security provision, i.e. it requires an owner signature. However, this is deficient for checks and other hard copy documents, e.g., the signature can be forged.

Typical security provisions for people who interact via computers are passwords, answering personal questions (like “What is your maiden's name”), pins in cards, voice and finger prints, etc. This system are used in ATM machines and in computer controlled/monitored entrances. More complex systems that utilize random questioning, automatic speech recognition and text-independent speaker recognition techniques are disclosed in U.S. patant application Ser. No. 871,784, entitled “Apparatus and Methods for Speaker Verification/ldentification/Classification Employing Non-Acoustic and/or acoustic Models and Databases” to Kanevsky et al. filed on Jun. 11, 1997, and that is herein incorporated by reference in its entirety.

### STATEMENT OF PROBLEMS WITH THE PRIOR ART

Prior art security hardcopy documents is deficient.

Check books can be lost or stolen. Some check books contain copies of signed checks. This would allow a thief to imitate a user's signature in new checks. This problem cannot be resolved even with check books without copy pages. An impostor can get access to owner signatures from some other sources (e.g. signed letters). This makes difficult for a bank to prevent payment for checks that were signed by a thief or for merchants to verify an owner's identity.

Another problem with existing check books are that they usually have the same level of protection independently of amount of money that an owner is writing in a check Whether an owner processes $5 or $5,000 on a check—he/she typically provides the same security measure—the signature. That is, typically security like check cashing has only one level of security, e.g. check of signature. A security provision is needed that can provide more security for access to more valuable things.

Prior art security for computer systems is also deficient. Passwords and cards can be stolen. An eavesdropper may learn answers to security questions. Also, a person can forget passwords. Fingerprints and voice prints alone do not provide guaranteed security since they can be imitated by a skillful thief

### OBJECTS OF THE INVENTION

An object of this invention is an improved system and method that provides secure access to secured locations, accounts, and/or information.

An object of this invention is an improved system and method that uses random visual patterns or objects that provides access to secured locations, accounts, and/or information.

An object of this invention is an improved system and method that uses random visual patterns that provides access to secured locations, accounts, and/or information with various selectable levels of security.

An object of this invention is an improved system and method that uses random visual patterns that provides secured access to financial accounts and/or information.

An object of this invention is an improved system and method that uses random visual patterns to provide secured access to financial accounts and/or information over a network.

### SUMMARY OF THE INVENTION

The invention presents a user (person accessing secured data, goods, services, and/or information) with one or more images and/or portions of images. As a security check, the user selects one or more of the images, possibly in a particular order. The set of selected images and/or the order is then compared to a set of images known to an agent (e.g. stored in a memory of a bank) that is associated with the user. If the sets match, the user passes the security check. Typically, the images and/or image portions are familiar to user, preferrably familiar to the user alone, so that selection and/or sequence of selection of the images/portions would be easy for the user but unknown to anyone else.

### BRIEF DESCRIPTION OF THE DRAWINGS

The foregoing and other objects, aspects and advantages will be better understood from the following detailed description of preferred embodiments of the invention with reference to the drawings that are include the following:

FIG. 1 is a block diagram showing some preferred variations of visual patterns and how they are used in different security levels.

FIG. 1A shows examples of visual images.

FIG. 1B shows example of implementation of preferred embodiments on a back page of a check book.

FIG. 2 is a block diagram of a system that compares a user selection of parts of a preprinted visual pattern to a database on a access server to verify user access.

FIG. 3 is a block diagram of a system that compares a user selection of parts of a printed visual pattern to a database on a access server to verify user access where the visual pattern is copied on a document when the user presents the document to an agent.

FIG. 4 is a block diagram of a system that uses the invention to verify user access over a networking system.

FIG. 5 is a block diagram of one preferred visually pattern showing a particular marking pattern that the user uses to select a portion of the pattern and the system uses, optionally with other biometrics, to verify the user access.

FIG. 6 is a flow chart of a process performed by the access server to generate familiar and random portions (e.g. by topic, personal history, profession, etc.) of the visual pattern.

FIG. 7 is a flow chart of a process performed by the access server to verify user access by the selection of portions of the pattern.

FIG. 8 is a flow chart of a process further performed by the access server to verify user access by the user marking pattern and/or other user biometrics.

FIG. 9 is a flow chart of a process for classification of user pictures and associating them with user personal data.

FIG. 10 is a flow chart of a process running on a client and/or server that provides/compares selected images to a database set of visual images before granting a user system access.

### DETAILED DESCRIPTION OF THE INVENTION

A non limiting example using a hard copy document, such as a check, is now described. Every check contains several (drawn/printed) pictures on them, e.g. on the back side. One of several pictures on each page would represent a familiar object to the owner of this check book and others should represent an unfamiliar or unrelated to the user objects. In a general sense, “familiar” refers to concepts that the user can immediately relate to because they are: 1) related to his interest, activities, preferences or past history etc. and/or 2) direct answers to question checking the user's knowledge (independently on how these questions are generated). For example, (familiar) pictures can represent this owner's face or owner's family members, his house building, view of some objects at places that he/she visited or spent his/her childhood etc.

The user of a check book would view several pictures on a back side of the check book list and cross with a pencil a picture (select as subset of images/pictures) that most remind to him some familiar person, place, and/or thing, and/or pattern thereof This check can be screened with a special gesture recognition device that detects what was a user's choice (selection). This screening can be done either at a bank where a check arrived or remotely from a place (store/restaurant etc.) at which a user pays with his check for ordered services/goods. Screening also can be done at special “fraud” servers on a network that provide authenticity check for several banks, shops or restaurants. A user choice for a picture is compared with a stored table of images that are classified as relevant to the user at a special bank (or “fraud” server) database. This bank database can created from pictures provided by the user. Some pictures can be created as memorable images linked to the user's personal history, e.g. country and/or town where he was born or that he visited. For example, if the user was born in Paris and resides in New-York, the list of memorable pictures can include the Eiffel tower. In this case a list of several pictures at a back side of a list could contain several famous buildings from different countries (including the Eiffel Tower). A user could be shown a list of possible (memorable) symbols before there use in check books. On average one could use 10-20 (familiar) symbols per a check book, possibly in addition to other symbols not associated and/or unfamiliar to the user.

An other method to improve the user authentication is the following. Every check can contain questions about a user. Questions can be written on back of each check in an unused space. Questions can be answered either via (handwritten) full answer or via multiple choice notations. If questions are answered via multiple choices (e.g., by crossing a box with a user's answer) they can be easily screened in a business location (e.g. a shop) via a simple known reader device, communicated to a remote bank via a telephone link, and checked there. If questions are answered via handwriting—handwriting verification can be used at a bank where check would arrive. There are known systems for verifying handwriting automatically, e.g. over a network, as well. Sets of questions can be different in each check in a checkbook.

Examples of questions are: “How many children you have? Where were you born etc.?” This method also can be combined with the method of random pattern answers that was described above.

Other known methods, like biometrics can be used with the invention. One can get biometrics from user's handwritten marks: signature, crossing line (for a picture), or a double cross mark for a multiple answers choice. These biometrics include curvature, width, pressure etc. A user can be asked to produce nonstandard “exotic” lines while he crosses a chosen image on a check list. If such cross lines are left on the back of the check list they will not be copied on other check lists (contrary to signatures). This would prevent a thief from imitating owner's characteristic cross lines. This also provides additional protection if an impostor somehow gets access to an owner signature (e.g. from signed owner's letter).

These several methods of protection can be used to provide a hierarchical level of protection depending on amount of money that is processed in a check. A back side of a check list can be divided in several parts. Each such part can contain several random pictures or questions with answer prompts. Each such part can correspond to different amounts of money to be processed and/or information accessed. For example, a user is required to process the first part on a check list (by crossing/marking some picture(s)) if the amount of money is less than $25. But the user is required to process two parts if the amount is higher than (say) $50 etc. Since the probability of occasional guess is decreasing with more parts processed, this method provides a different level of protection.

Documents, like checks, can be printed with these pictorial (and other) security provisions automatically printed on them. A facility for generation and printed random images would include a device that reads a user's database of familiar/selected visual images and prints on the document/check lists of certain of these visual images. Images in this facility can be classified by topics. There can be also a stock of images that is not familiar to a user. There can be an index table that shows which images are not familiar to each user. There can be also some semantic processor that is connected to the user personal data/history and label images as related or not related to each user data/history. One use of this system would be in a bank that issues checkbooks. In this case there could be a communication link (network)/service with the bank to put the boxes on the check (with all standard security procedures like encryption etc.).

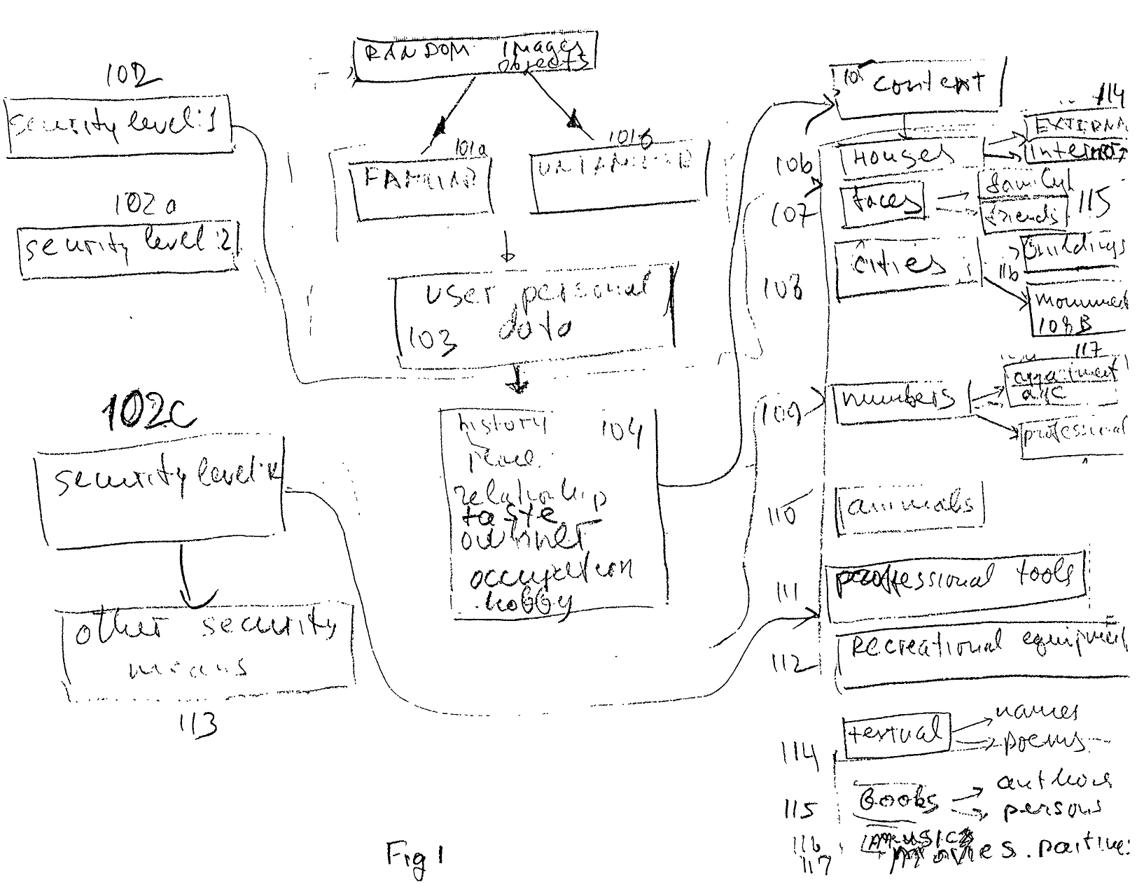

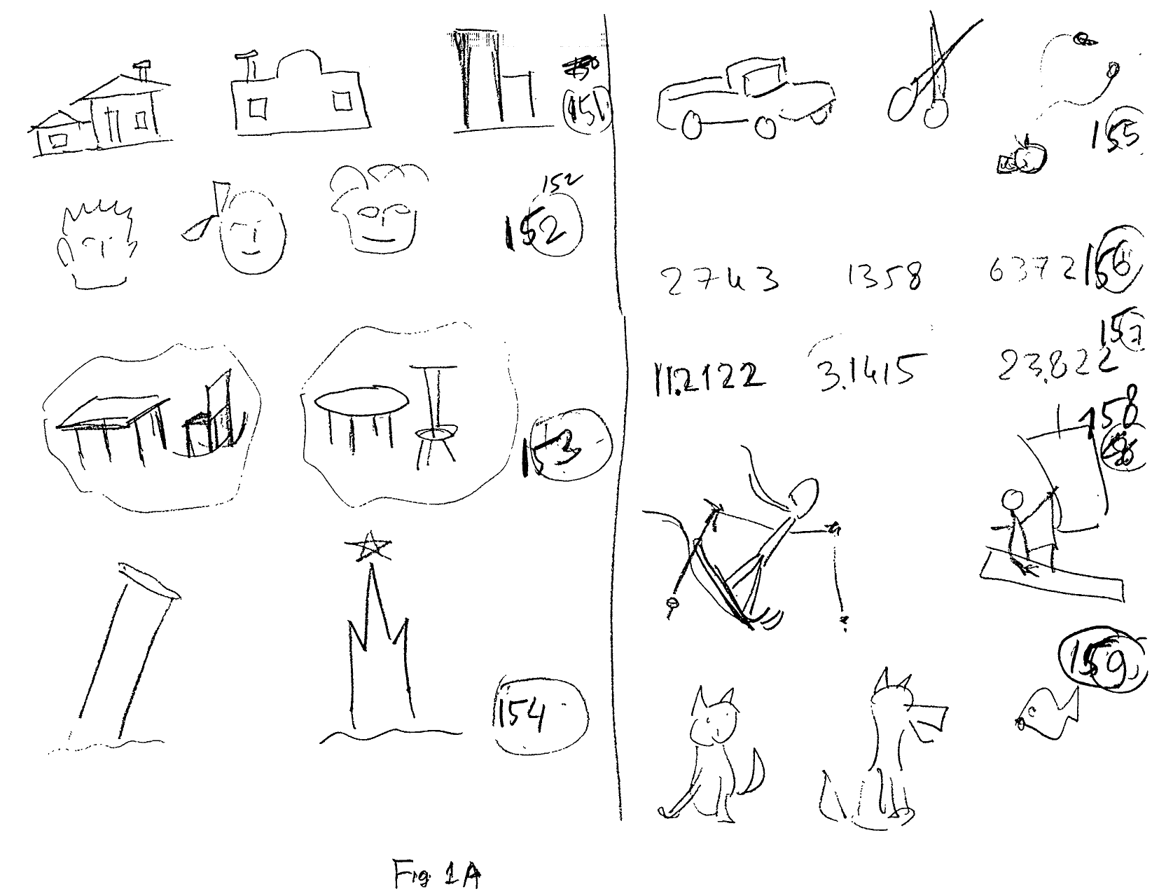

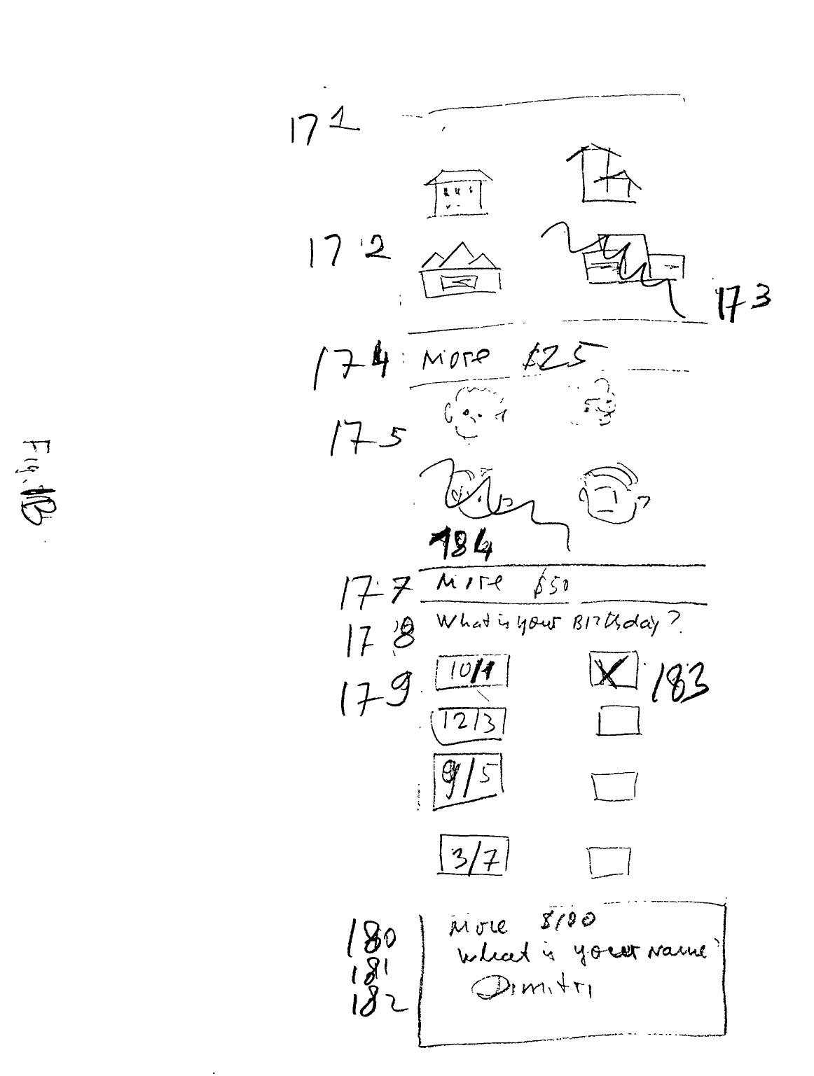

Now refer to FIG. 1. A person who requires access to a secured system is required to identify familiar random images or objects that are presented to him. Images can be represented in form of pictures, sculptures and other forms that can be associated with visual images. Objects can be represented in form of numbers, words, texts and other forms that indirectly represent an object (not visually). These random images and objects are contained in block 100. Images can be split in two categories—familiar (101a) and unfamiliar (101b) to a user. The images that are presented to a user are based on a user personal data 103. This personal data includes facts that are represented in 104—for example, facts related to a user history, places where he lived or visited, relationship with other people, his ownership, occupation, hobbies, etc. Subjects that are mentioned in 104 can have different content features (105). Examples of content features are shown blocks 106-117 in FIG. 1 and include houses 106, faces 107, cities, 108, numbers 109, animals 110, professional tools 111, recreational equipment 112, texts (e.g., names, poems) 114, books (by author, title, and/or person owning or about) 115, music 116, and movies/pictures 117.

FIG. 1A illustrates some of images in 106-117. A user should distinguish one familiar image on each line (1-9) in FIG. 1A. Below are some explanations to blocks 106-112 (with related examples from FIG. 1A)

106—images related to a user house:—external (151 in FIG. 1A) and interior (153 in FIG. 1A);

107—faces: family members (wife, children, parents etc.) and friends (152 in FIG. 1A);

108—cities: famous city buildings (154 in FIG. 1A), etc.;

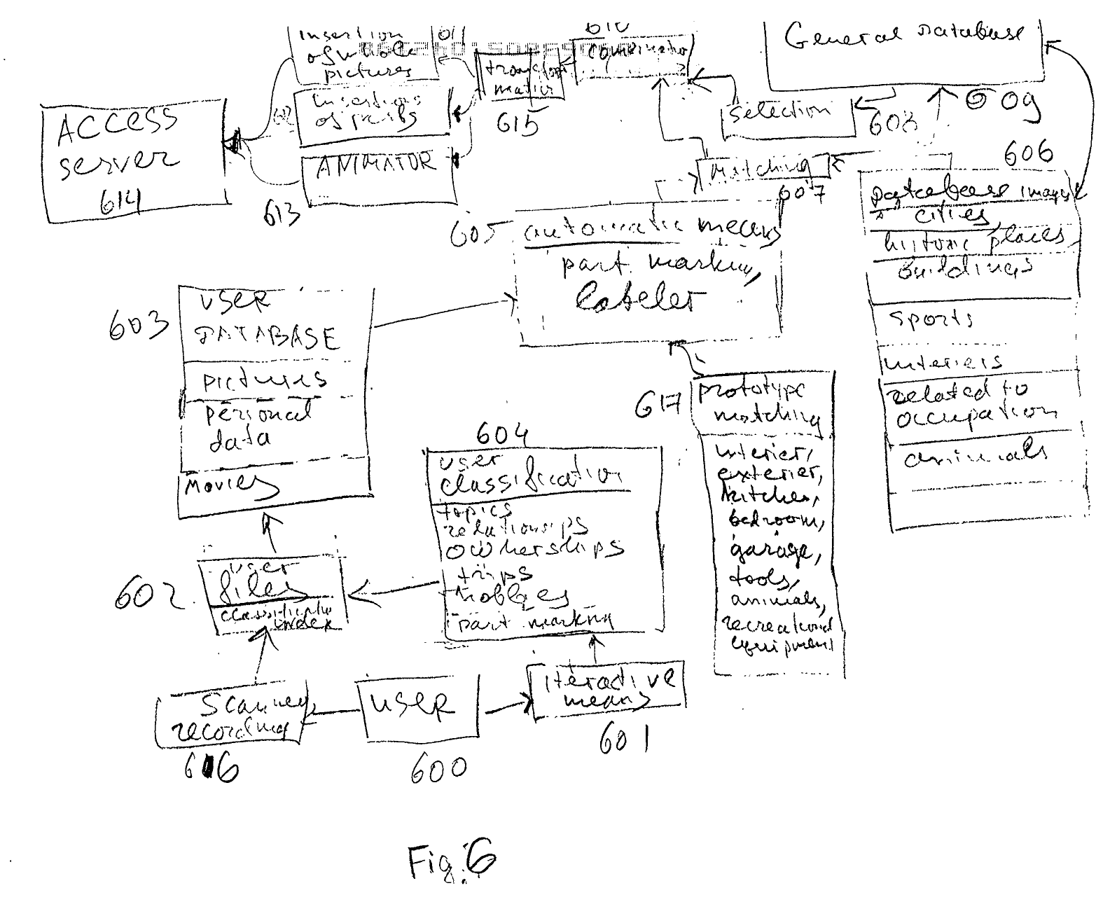

109—numbers: user apartment numbers (156 in FIG. 6), age, professional related 157;

110—animals that owned by a user (e.g. 159 in FIG. 1A).

111—professional tools (e.g. a car for a driver, scissors for a tailor etc. in 155, FIG. 1A).

112—recreational equipment (e.g. skiing downhill or sailing in 158, FIG. 1A).

These random images are displayed to a user in a quantity and complexity to reflect different security levels (102, 102a, 102c). The higher security level is the more random familiar pictures/images are required to identify a user. The number of random pictures among which a familiar picture is stored also define a security level. The more random pictures are displayed per one familiar picture the less chances that an intruder accidentally identifies a correct image. Different topics related to images also provide different security level. For example, the security level (1) that involves displaying houses is less secured then the security level (102a) that requires to identify familiar numbers. (For example, the second number in FIG. 1A, 7 is a ratio of length of a circle to its diameter. It would be easily distinguished by a mathematician from other two random numbers).

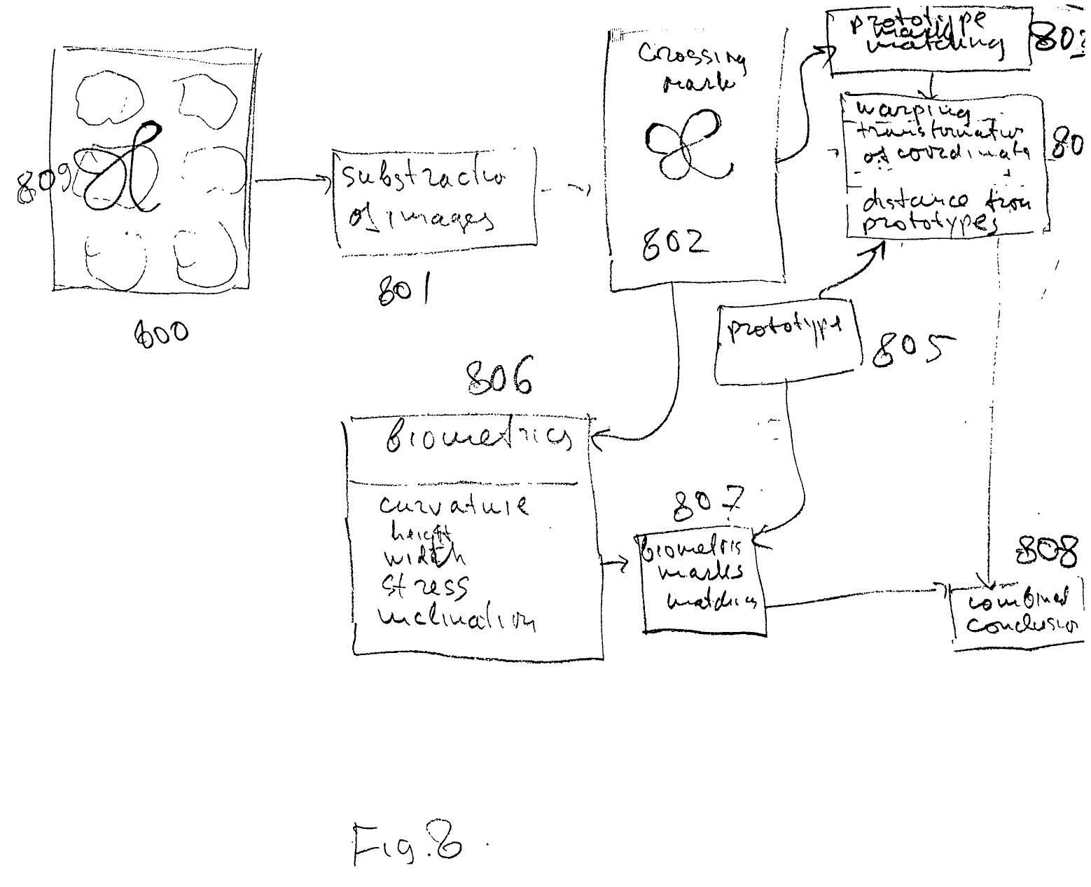

The highest security level 113 combines random image security method with other security means 113. Other security means can include use biometrics (voice prints, fingerprints etc.), random questions. See U.S. patent application Ser. No. 376,579 to W. Zadrozny, D. Kanevsky, and Yung, entitled “Method and Apparatus Utilizing Dynamic Questioning to Provide Secure Access Control”, filed Jan. 23, 1995, which is herein incorporated by reference in its entirety. A detailed description of preferred security means is given in FIG. 8.

The FIG. 1B shows the example of a check list 171 with hierarchical security provision. First part (172 ) contains pictures of buildings and a user crossed (173) one familiar building. The second part is required to be processed if the amount of money on a check list is larger than $25 (as shown by an announcement 174). The second part consists of images of faces (175) and a crossed line is (176) . The last part is processed if the amount of money exceeds $50 (177) and consists of a question (178) and answer prompts (e.g. (179)). The chosen answer is shown in (183) via double crossed line.

A next security level (180) if money exceeds $100 provides random questions that should be answered via handwriting. In this example, a question (181) asks what is the user name. An answer (182) should be provided via handwriting, This allows to check the user knowledge some data and provide handwriting biometrics for handwriting biometrics based verification. Since the probability of occasional guess is decreasing with more parts processed, this method provides several levels of protection.

Note that it is possible to display random objects that are not represented as visual images. One example—numbers—was given above. Other examples could include names of persons. A user could be asked to identify familiar names from a list of names. One can construct examples with textual objects (such as different sentences, some of which should be familiar to a user). The invention could be easily extended to non visual objects. We consider visual images as more convenient than non-visual images since they are more easily proceeded at a glance and have larger variety of representative forms. For example, a face of the same person can be shown from several views thereby providing different images.

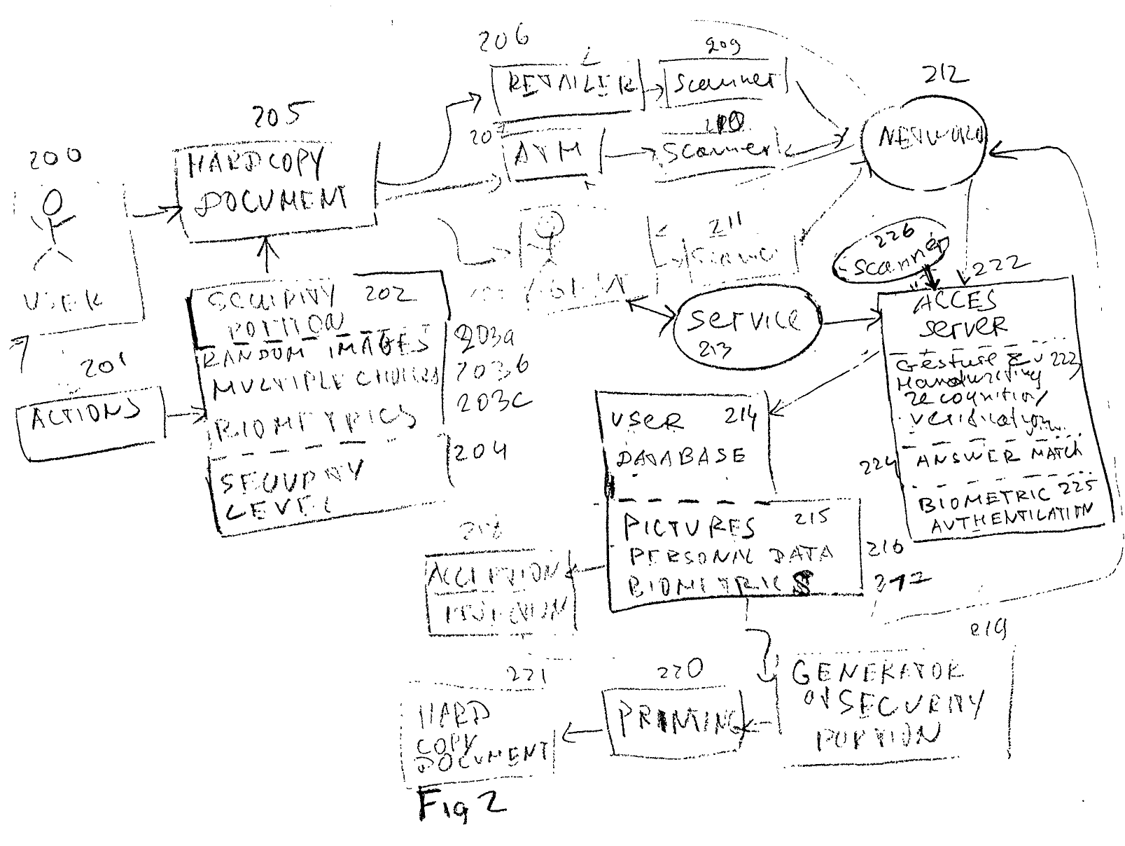

Refer to FIG. 2.

The user (200) of a hard copy document (205) (e.g. a check book) prepares a security portion (202) of this document before presenting this document at some location (e.g. give a check book to a retailer 206, ATM 207, agent 208). This security portion is used to verify the user identity in order to allow him receive some services, pay for goods, get access to some information, etc.

The security portion consists of several sections: random images (203a), multiple choices (203b) and user biometrics (203c) that will be explained below. The security level 204 is used to define what kind of and how many random images, multiple choices, and biometrics are used (like it was shown in FIG. 1B).

User actions (201) in the security portion consist of the following steps: in step 203a perform some operations in a section of random images (FIG. 1A), in step 203b perform some operations in a section of multiple choices (FIG. 1B), in step 203c provide some personal biometrics data (e.g. 184 in FIG. 1B). This biometrics data include user voice prints, user fingerprints and user handwritings. In what follows, these steps will be explained in more details. In these explanations, we assume for the clarity and without limitation that a hard copy document 205 is a check book. But similar explanations can be done for any other hard copy documents. In addition, the documents 205 can be soft copy documents, e.g., as provided on a computer screen, and the pictures can be images displayed on that screen.

The user views several pictures on a back side of a check book list and selects, e.g. crosses with a pen/pencil a picture/image that most resembles to him some familiar pattern. Every check list in (205) contains several (drawn) pictures (203a) on their back sides. Examples of such pictures are given on FIG. 1A. One of several pictures on each page could represent a familiar object to the owner of this check book and others could represent an unfamiliar or unrelated to the user objects. For example, (familiar) pictures can represent this owner's face or owner's family members, his house building, view of some objects at places that he/she visited or spent his/her childhood etc.

This check is presented to a retailer (206) or to ATM (207) or to an agent (208) providing some service (213) (e.g. a bank service) or access (213). The document can be scanned at the user's place with a special known scanning device (209 or 210 or 211) and sent via the network 212 to an access server. In another option, the document can be sent to a server via a hard mail/fax (from 213 to 222 ) and scanned at the service place (226). The access server 222 detects what are user choices. (A special case of this scheme is the following. Users present checks in restaurants/shops and checks are sent to banks were these checks are scanned and user identities are verified using an access server and user database that belong to this bank).

A user choice for a picture is compared (via 224) with a stored table of images (215) that are classified as relevant to the user at a special user database (214 ). This database for pictures (214) can be created from pictures provided by the user. Some pictures can be created as memorable images linked to the user's personal history (216), e.g., country and/or town where he was born or that he visited. For example, if the user was born in Paris and resides in New-York, the list of memorable pictures can include the Eiffel tower. In this case a list of several pictures at a back side of a list could contain several famous buildings from different countries (including the Eiffel Tower). A user could be shown a list of possible (memorable) symbols before their use in check books. On average one could use 10-20 (familiar) symbols per a check book in addition with other not associated to a user symbols.

Another method to improve the user authentication is exploited in the section multiple choices (203b) and can be described as follows. Every check contains questions about a user. Questions can be written on back of each check that has unused space. Questions can be answered either via (handwritten) full answer or via multiple choices. If questions are answered via multiple choices (crossing a box with user answers 203b) they are processed in the same way as it was described for random images above. (For example, they can be scanned in a shop, communicated to a remote bank via a telephone link and checked there like a credit card). If questions are answered via handwriting—handwriting recognition/verification (223) can be used at an access server (222).

Set of questions can be different in each check list in a checkbook. Examples of questions are: “How many children you have? Where did you born etc.?” This method can be combined with the method of random pattern answers that was described above.

One can get biometrics (203c) from user's handwritten marks: signature, crossing line (for a picture), or a double cross mark for a multiple answers choice. These biometrics include curvature, width, pressure etc. A user can be asked to produce nonstandard “exotic” lines while he crosses a chosen image on a check list. If such cross lines are left on the back of the check list they will not be copied on other check lists (contrary to signatures). This would prevent a thief from imitating owner's characteristic cross lines. This also provide additional protection if an impostor somehow got access to an owner signature (e.g. from signed owner's letter). The prototypes for user biometrics and handwriting verification are stored at (217) in users database (214). (Hardware devices that are capable to capture and process handwriting based images are described in A. C. Downton, “Architectures for Handwriting Recognition”, pp. 370-394, in Fundamentals in Handwriting Recognition, edited by Sebastiano Impedovo, Series F: Computer and System Sciences, Vol. 124, 1992. Examples of handwriting biometrics features and algorithms for processing them are described in papers presented in the Part 8, Signature recognition and verification, in the same book that is quoted above). These references are incorporated by reference in their entirety.

Information on whether a user access was granted/rejected (218) is sent to the service provider 213 via network 212.

As described above, a separate facility can be a device (219) that reads a users database and prints (220) pictures and questions/answer prompts on check book lists (221). Check books with generated security portions can be sent to users via hard mail (or to banks that provide them to users).

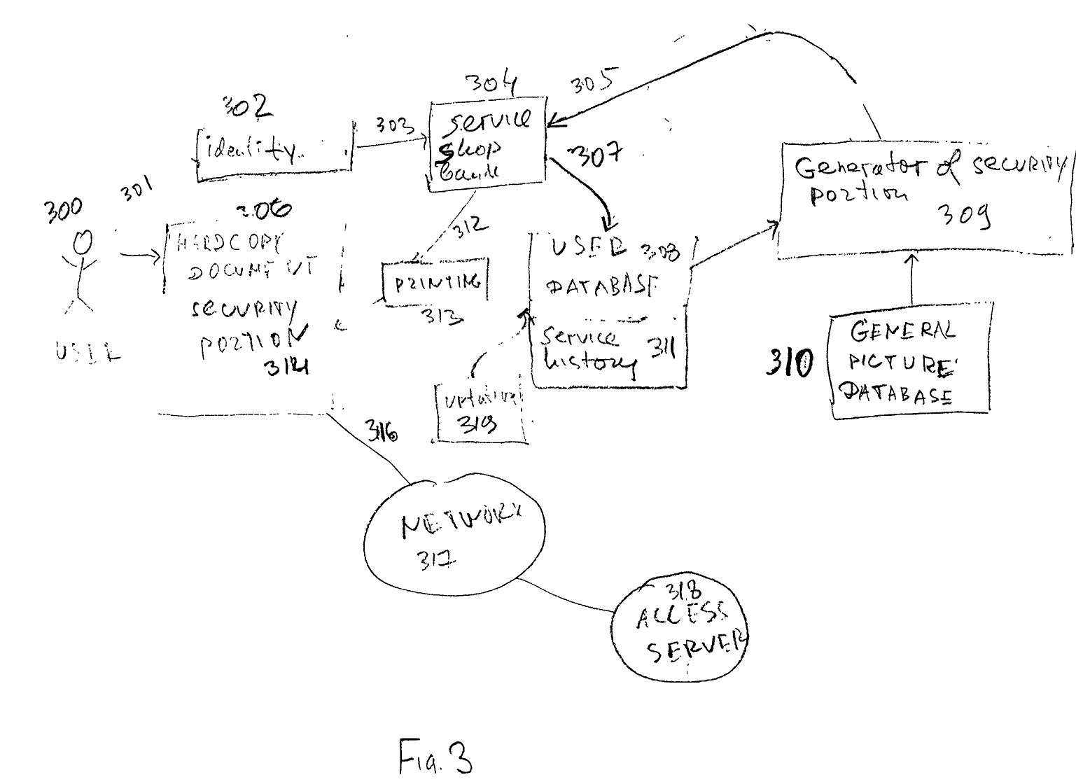

Refer to FIG. 3 which shows an embodiment where a user has no a hard copy document (e.g. a check book) with a preprinted security portion. Refer to FIG. 2 for a descriptions of features that FIGS. 2 and 3 have in common.

A user 300 that wants to buy some goods (e.g. in a shop) or access some service (e.g. in a bank) (304) presents there his/her identity (302) via communication connection (303). This identity is either the user name, or a credit card number, or a pin etc. The identity (302) is sent via (307) to a user database (308). The user database (308) contains pictures, personal data and biometrics of many users (it is similar to the user database 214 in FIG. 2). The user database (308) contains also service histories of all users (311). A service history of one user contains information on what kind of security portions was generated at their hard copy documents (306) in previous requests by this user for services. At the user database (308) the file that stores this user's (300) data is found. This file contains pictures that are associated with the user (300), personal data of the user (300) (e.g. his/her occupation, hobby, family status etc.) and his biometrics (e.g. voiceprint, fingerprint etc.). This file is sent to Generator of Security Portion (GSP) (309). GSP selects several familiar to the user (300) pictures and insert them in random (not associated with the user (300) ) images from a general picture database (310). This general picture database contains a library of visual images and their classification/definition (like people faces, city buildings etc.).

For example, if GSP produces from (308) a picture of a child face (e.g. a user's son) a set of children faces from (310) are found (that are not associated with the user's family) and combined with the picture produced by GSP. The other sections of security portion: random questions and prompt answers are produced by GSP in similar fashion. GSP matches the user's service history (311) to produce security provision that is different form security portions that were used by the user (300) in previous visits of (304). The security provision produced by GSP is sent back to (304) and printed (via (313)) as security portion (314) in the user's hard copy document (306). After the security portion (314) is printed the user (300) proceeds the hard copy document (306) exactly as the user 200 in FIG. 2. In other words, he/she makes some operations on the security portion (314) (cross familiar pictures, answer random questions etc.) and this user provided information is sent via network (306) to access service (318) for the user verification. The user database of pictures (308) is periodically updated via (319). The user database get new images if there are changes in the user life (e.g. marriage), or external events occurred that are closely relevant to the user (stock crash, death of the leader of the user native country etc.).

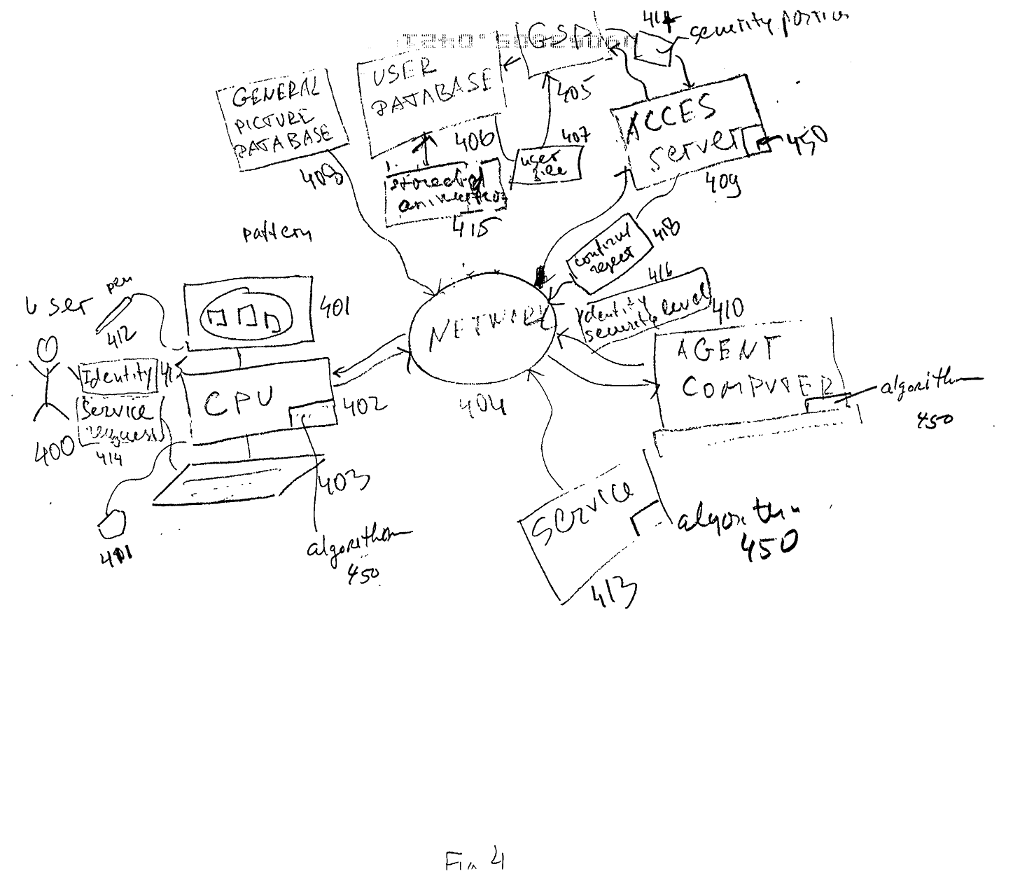

Refer to FIG. 4.

Using this invention, a user 400 can also process random visual images that are displayed on a computer monitor (401) (rather than on a hard copy document 306). Thus many aspects of FIG. 4 are similar to those FIG. 3. The user 400 sends to an agent 410 a user identity 415 and a request 414 for access to some service 413 (e.g. his bank account). This request is entered via a known input system 403 (e.g. a keyboard, pen pallet, automatic speech recognition etc.) to a user computer 402 and sent via network 404 to the agent/agent computer 410. The agent computer 410 sends the user identity and a security level 416 to an access server 409. The access server 409 activates a generator of security portion (GSP) 405. The GSP requests and receives from a user database service 406 data 407 related to the user 400. User database services may also include animated images (movies, cartoons) (415) that either were stored by the user (when he enrolled for the given security service) or produced automatically from static images. This data include visual images familiar to the user 400. The GSP server also obtains random visual images from 408 (that are not familiar to the user or not likely to be selected by the user) and inserts visual images from 408. The GSP server uses the security level 417 to decide how many and what kind of images should be produced for the user. Other security portions (e.g. multiple choice prompts) also can be produced by the GSP module similarly as in discussed above in FIG. 2. The access server 409 obtains the security portion 416 from 405 and sends it to the monitor 401 via network 404 to be displayed to the user 400. The user 400 observes the monitor 401 and crosses familiar random pictures on the display 401 either via a mouse 411, a digital pen 412 or the user interacts via the input module 403. In a special case images can be animated—either duplication of portions of stored movies or cartoons (with inserted familiar images). A user can stop a movie (cartoon) at some frame to cross a familiar image. User answers are sent back to the access server and a confirmation or rejection 418 is sent via the network 404 to the agent 410. The access server can use in its verification process also user biometrics that were generated when the user 400 chose answers. This biometrics can include known voice prints (if answers were recorded via voice), pen/mouse generated marking patterns (if the user answered via a mouse or a pen) and/or fingerprints. If the user identity is confirmed the agent 410 allows the access to the service 413.

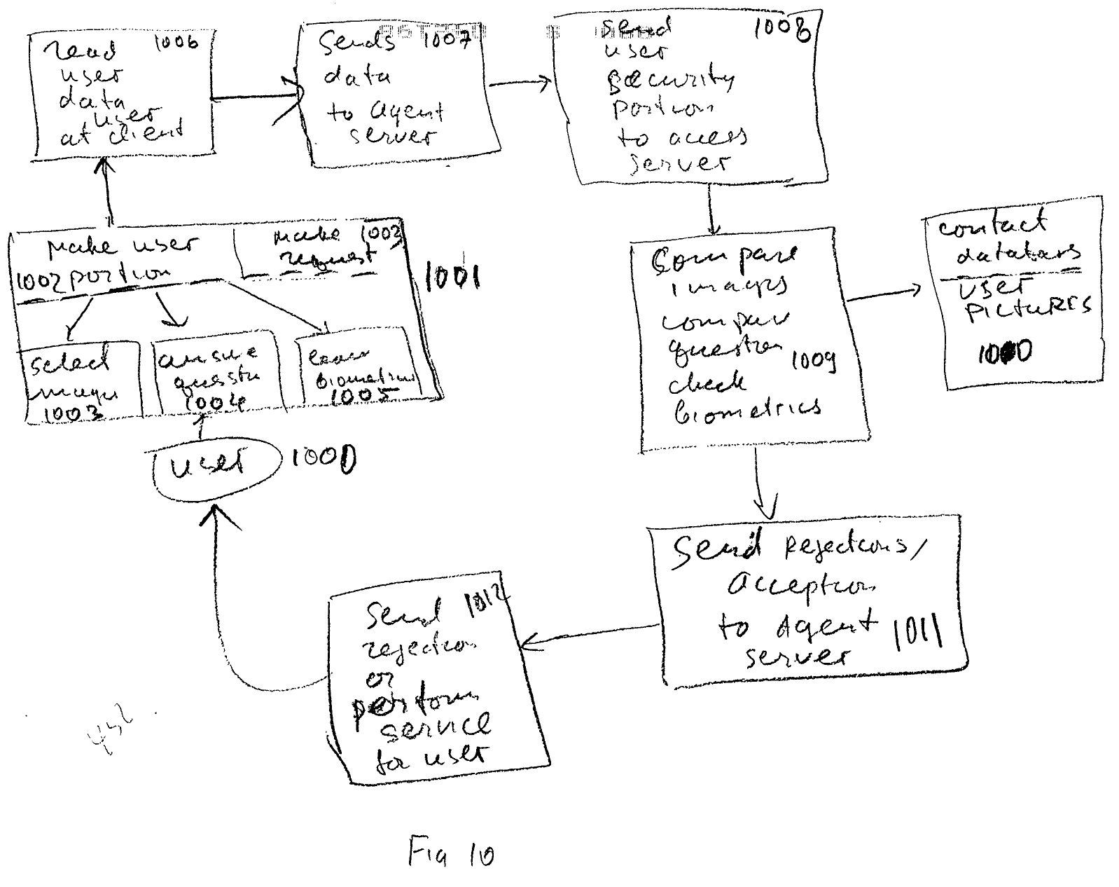

Modules 450 represent algorithms that are run in client and/or servers CPU 402, 410, 413 and 409 and support processes that are described in details in FIG. 10.

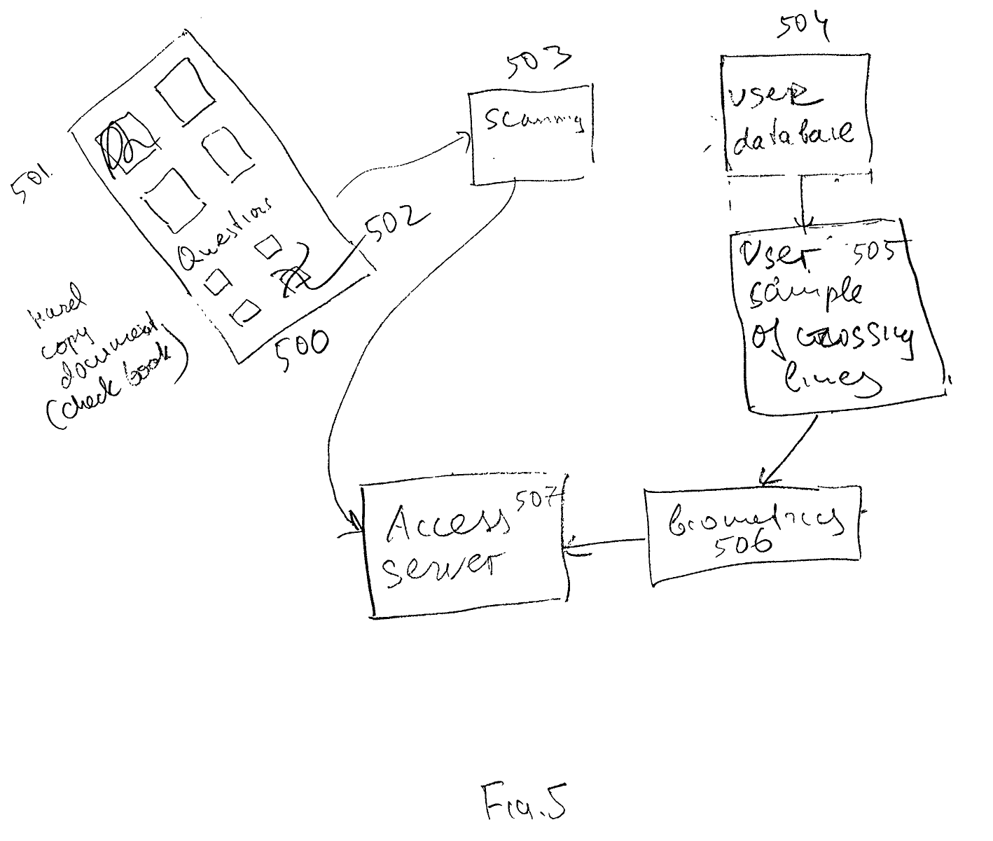

Referring to FIG. 5, one can get biometrics from user's handwritten marks: signature, crossing line (for a picture) (501), or a double cross mark (502) for a multiple answers choice. These biometrics (506) include curvature, width, pressure etc. A user can be asked to produce nonstandard “exotic” lines while he crosses a chosen image on a check list (500). Such crossing lines are scanned by known methods 503 and sent to access server 507 (similar to procedures that were described in previous figures). If such cross lines are left (for example) on the back of the check list they will not be copied on other check lists (contrary to signatures). This would prevent a thief from imitating owner characteristic cross lines. This also provide additional protection if an impostor somehow got access to an owner signature (e.g. from signed owner's letter). The prototypes for user biometrics and handwriting verification are stored at (505) in users database (504). Users can be asked to choose and leave their typical “crossing” marks for storing in the user database 504 before they will be enrolled in specific services. The access server verifies whether user biometrics from crossing marks fit user prototypes similarly as it is done for verification of user signatures (references for a verification technology were given above).

Refer to FIG. 6

Before a user can start to use security provisions that were described in previous figures he/she might enroll in a special security service that collects user data and generate a security portion .

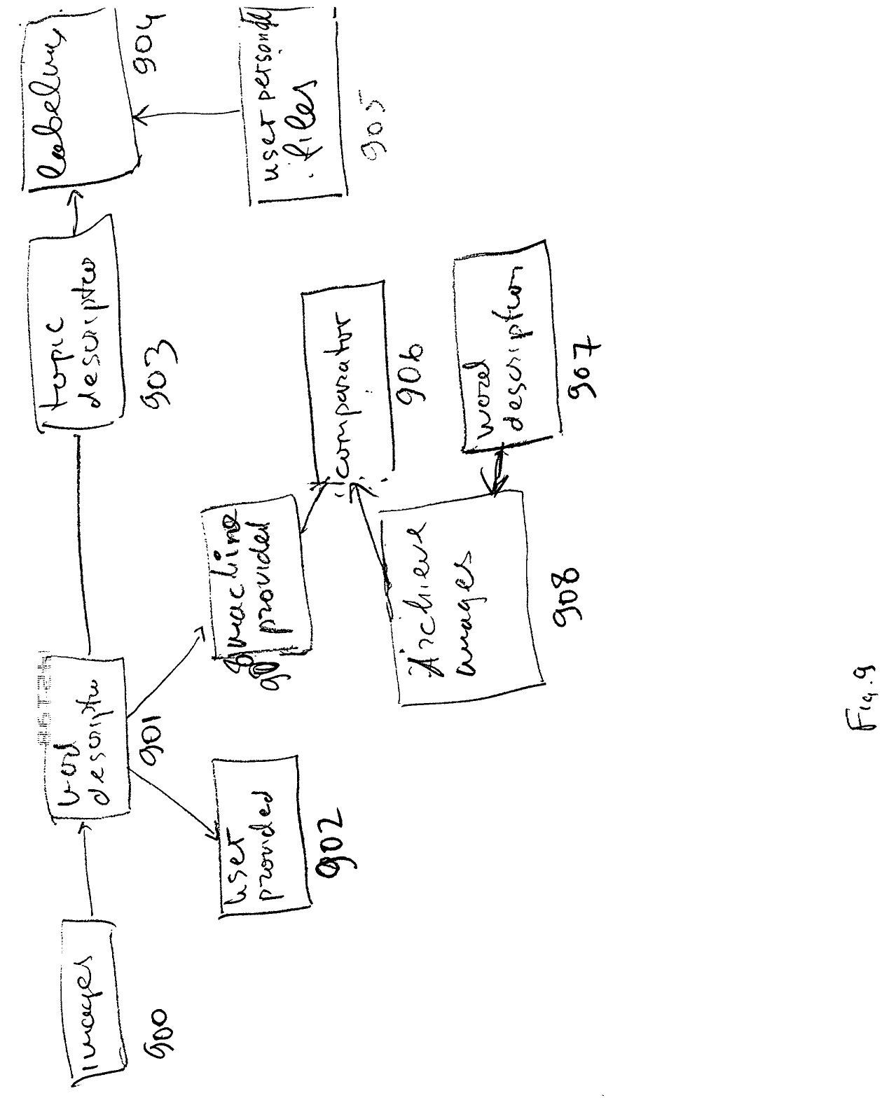

A user 600 provides a file with his personal data and pictures (family pictures, home, city, trips etc.) (602). While user pictures are scanned (via 616) the user classifies pictures in 604 according their topics (family, buildings, hobbies, friends, occupations etc.). The user 600 interacts with the module 604 via iteractive means 601 that include some applications that provide a user friendly interface. For example, pictures and several topics are displayed on a screen in order that the user could relate topics to pictures. The user also indicates other attributes of pictures in the user file 602 such as an ownership (house, car, cat, dog etc.), relationship with people (children, friends, coworkers), associations with places (birth, honeymoon, user's college etc.), associations with hobbies (recreational equipment, sport, games, casino, books, music etc.), associations with a user profession (tools, office, scientific objects etc.), and so on. This classification is done also for movie episodes if the user stores movies in the user file 602. The user also marks parts of pictures and classifies them (for example, indicating a familiar face in a group picture). The user can produce this classification via computer iteractive means 601 that display classification options on a screen together with images of scanned pictures. The user file 602 with user pictures and user classification index is stored in a user database 603 (together with files of other users). User data from 603 is processed by the module 605 that produces some classification and marking of picture parts via automatic means 605. More detailed descriptions of how this module 605 works and interacts with other modules from FIG. 6 are given in FIG. 9.

This module 605 tries to classify images that were obtained from the user and that were not classified by the user. Assigning of class labels to images and its parts is done similarly as it is done for input patterns in an article Bernhard E. Boser, “Pattern Recognition with Optimal Margin Classifiers”, pp. 147-171 (in Fundamentals in Handwriting Recognition, edited by Sebastiano Impedovo, Series F: Computer and System Sciences, Vol. 124, 1992).

One of the methods that the module 605 uses is matching images that were not classified by the user with image that the user classified in 604. For example, the user marked some building on the picture as the user home. The module 605 marks and labels buildings on other user pictures if they resemble the user house. Similarly, the module 605 labels faces on pictures if they resemble pictures that were classified by the user in 604. The module 605 also classifies particular pictures using a general association that the user specified. For example, the user may specify several pictures as house related. Then the module 607 would identify what pictures show interior and exterior objects of the user house. The module 607 labels accordingly pictures that show a kitchen, a bedroom, a garage etc. (See descriptions to FIG. 9 for more details). The module labels animals or fishes it they are shown on the picture that are related to the house as user owned animals (and label them as dogs, cats etc.). Similarly, if the user associates a package of pictures with his profession, the module 605 would search for professional tools on the picture etc. This labeling of picture items accordingly to the user association is done via prototype matching in the module 617. The module 617 contain idealized images of objects that are related to some subjects (e.g. a refrigerator or spoon for a kitchen, a bath for a bathroom etc.). Real images from user database are matched with idealized images in 617 (via standard transformation—warping, change of coordinates etc. One can use also content-based methods that are described in J. Turel et al., “Search and Retrieval in Large Image Archives”, RC-20214 (89423) Oct. 2, 1995, IBM Research Division, T. J. Watson Research Center ). If some objects on the user pictures are matching prototypes in 617 then the picture is related with some subject (for example, if a car inside of a room is found in a picture the picture is associated with a garage etc.).

User images are also matched with a general database of images 609. The database 609 contain a general stock of pictures (faces, cities, buildings etc.) not related to specific users from 603. The module 607 matches a topic of pictures from 605 and select several pictures from 606 with the same subject. For example, if a subject of the user picture is a child face, a set of general child faces from 609 are chosen via 608 and combined in 610 with the user child picture.

A module 606 contains general images from 609 that are labeled in accordance with their content: cities, historic places, buildings, sports, interior, recreational equipment, professional tools, animals etc. This module 606 is matched with personal data from 603 via a matching module 607. When the module 607 reads some facts from personal data (like occupation, place of birth) it searches for relevant images in 606 and provides these images as images that are associated (familiar) to the user. For example, if the user is a taxi driver, the module 607 would pick up an image of taxi cab even the user did not presented such a picture in a his file 602. This image of a car would be combined with other objects related to different professions, like an airplane, a crane etc. If the user is shown several objects related with different professions he/she would naturally choose an object related to his/her profession.

Images that are associated with (familiar to) the user are combined in 610 with unrelated to the user images from 609. In the module 615 these images are transformed. Possible transformation operations are the following: turning colorful pictures to colorless contours, changing colors, changing a view, zooming (to make all images of comparable sizes in 611 and 612) etc. (these all transformations are standard and are available on many graphic editors). The purpose of these transformations is to make either more difficult for the user to recognize a familiar objects or provide a better contrast for user crossing marks (it may be difficult to see user crossing marks on a colorful picture). The transformation block 615 may replace some parts of an image with error images (that include errors in feature or errors in colors) in order that the user would be required to detect an error. Some transformations are necessary in order to insert some parts of images in whole pictures (in 612). For example, some face in a family picture can be replaced with a face of a stranger (this is for a task in which the user should identify an error in a picture). Whole images are composed in 611. Images with inserted, changed parts are composed in 612. In a module 613 animated pictures are presented. Images are presented to the access server 614 for further processing as described in previous figures.

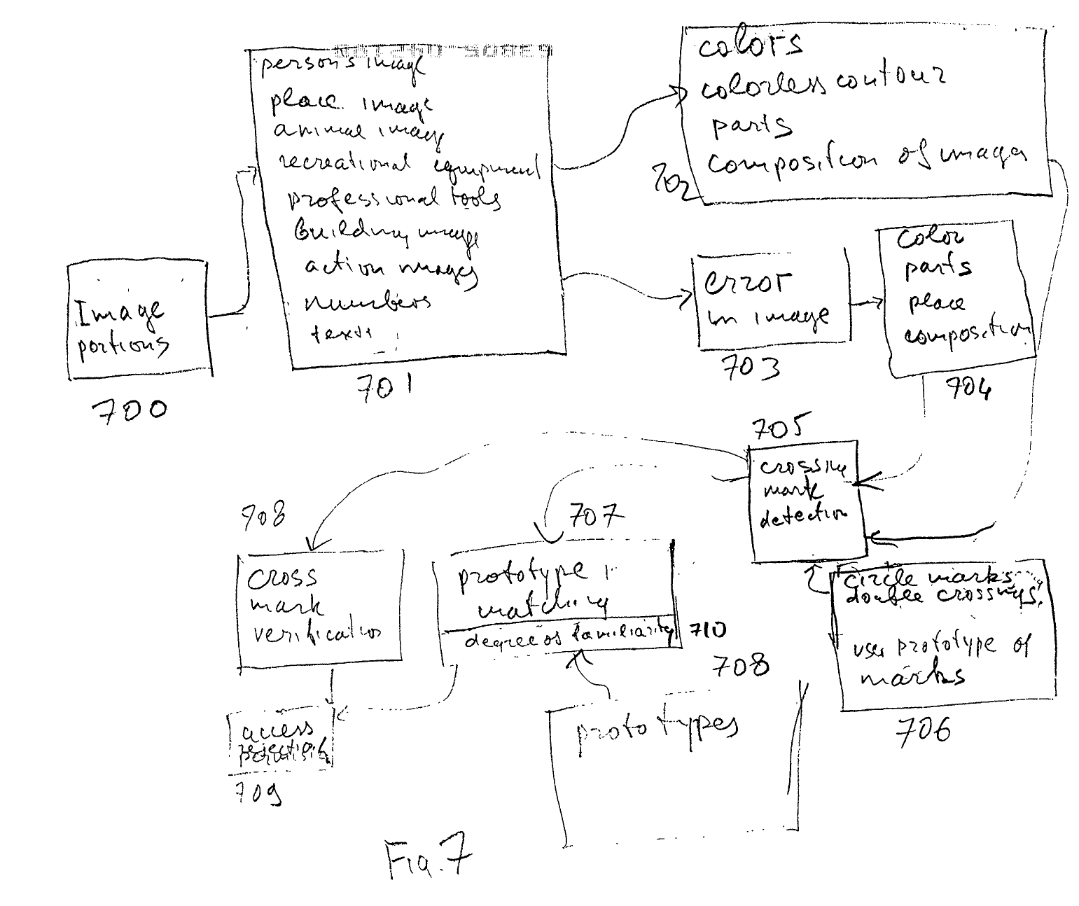

Refer to FIG. 7

The access server processes image portions some parts of which that were marked by the user. Image portions 700 can comprise the following objects (701): person's image, images of places, animal images, recreational equipment images, professional tool images, building images, numbers, textual images and action images (that show some actions, e.g. cooking swimming etc.). Images in 701 can be either colorful or represented as colorless countors, they can consist of some parts that require the user attention (e.g. an eye or a teeth) or be composition of several images. These properties of images to which the user should pay attention are described in the module 702. The user may require to find errors in images (703). These errors can be in a color (e.g. a color of the user house), in a part (e.g. a wrong nose pattern on a familiar face), in a place (e.g. the wrong place for a refrigerator in a picture of a kitchen), in a composition of images etc. (704). A module 705 detects user marks that were left on image portions. Types of marks are stored in a module 706 (e.g. circle marks, double crossings or user special crossing marks) . This detection of user marks can be done by subtracting portion images (that are know from the access server) and detecting images of (crossing) marks that are left after elimination of portion images and comparing them with prototypes of user marks in a module 706. After detection of user marks relevant image portions are matched in 707 with prototypes in 708. Images can be classified by degree of familiarity to the user (in a module 710). For example, images family members can be considered as more familiar than images of some friends.

If the user chooses correctly a familiar image (or unfamiliar image in a set of familiar images) or detected a correct error the information about this is given to a accept ion/rejection module 709. Marks from the module 705 are sent to a module 708 for a mark verification. Mark verification is done similarly to signature verification (see for example, Fathallah Noubond, “Handwritten signature Verification: A Global Approach”, (in Fundamentals in Handwriting Recognition, edited by Sebastiano Impedovo, Series F: Computer and System Sciences, Vol. 124, 1992). Marks from a user are interpreted as different kind of signatures and marks are compared with stored user prototypes marks like they would be compared with stored user prototype signatures. In this module marks and biometrics from these marks are used to verify the user identity. The information about this verification is sent to the acceptation/rejection module 709. A final solution about user request acceptation/rejection is done in this module on a basis of all obtained information.

Refer to FIG. 8.

A digitized security portion (image patterns and a user mark 809) are represented by a module 800. (“Digitized” means that information is represented in digital form, for example, after scanning a hard copy document ). After subtracting images in 800 (via a module 801) one can get the user crossing mark image in 802. The user crossing mark is matching (in a module 803) with a stock of user prototypes for crossing marks (in a module 805). In order to achive the best match of the user crossing mark with some of stored prototypes the user crossing match is undergoing some transformations (in a module 804). These transformations include warping, coordinate transformations etc. Then a distance from a transformed user crossing mark to each prototype is computed and a prototype with the shortest distance is found. If the distance is below some threshold the system accepts a user crossing mark. This technique of matching user crossing marks to user prototypes is similar to matching user signatures to user prototype signatures. In a module 806 biometrics from the user crossing marks are collected and compared (via 807) with prototypes of user biometrics in the module 805. These biometrics include such characteristics of the user manner to write (or make crossing marks) as curvature, heights, width, stress, inclination etc. of line segments in the crossing mark 809. This technique of verification of biometrics from user crossing marks is similar to known verification technique of biometrics from user handwriting

In the module 808 a conclusion on a combined evidence from 804 and 807 done on acceptance or rejection of the user crossing mark. This combined conclusion can be represented as weighted sum of scores from each evidence from 870 and 804.

Refer to FIG. 9.

The module 900 contain images that a user provides in 603 (in FIG. 6). These images and components of these images are described (indexed) by words in 901. For example, an image of house is described by a word “house”, a part of this picture that displays an window is indexed by a word “window” etc. There can be additional labels that characterize degrees of familiarity of images to the user. This word/label description is provided by a user (902) and via automatic means (908). This module 908 works as follows. Images from 900 that were not labeled by a user in 902 are sent to a comparator 906 where they are matched with images in an image archive 908. This match of images with stored images uses a standard technology of matching image patterns with prototypes (see for example a reference J. J. Hull, R. K. Fenrich “Large database organization for document images”, pp. 397-416, in Fundamentals in Handwriting Recognition, edited by Sebastiano Impedovo, Series F: Computer and System Sciences, Vol. 124, 1992. This article also contains reference to other articles on searching and matching images in image archives. Another reference: J. Turel et al., “Search and Retrieval in Large Image Archives”, RC-20214 (89423) Oct. 2, 1995, IBM Research Division, T. J. Watson Research Center). Images in archives are already indexed with word descriptions (images were indexed with word descriptions when they were stored in archives). If the comparator 906 finds that some image from 900 matches an image in the archive 908 it attaches a word description from 907 to the image from 900 (or its part). After images are indexed with words they are provided with topical descriptions in 903. For example, images of kitchen objects (a refrigerator, microwave etc.) can be marked by a topic “kitchen”). This topic description can be done via classification of words and groups of words as topic related (via standard linguistic procedures using dictionary, e.g. Websters dictionaries). These topics are matched with labels for a user database 905 that are made by a labeling block 904. The block 904 classifies word descriptions s in the user personal database 905 (for example, it associates a topic “family” to items that describe user children and his wife 20 names, age, family activities etc.). If some topical descriptions from 903 matches some data from 905 via 904, images from 900 are related to user files 905 (for example images of tools in 900 can be related to a user profession that is given in 905).

Refer to FIG. 10 which shows what functions are performed by algorithms 450 that are running on client/servers 402, 209, 413 and 450 in FIG. 4.

An algorithm 450 on a user client 402 allows to a user 1000 (in FIG. 10) to perform a sequence of operations 1001 such as to make a request 1003, prepare a security portion that includes the following operations: select images 1003, answer questions 1004, leave biometrics 1005. The process at the user client read user data (1006) and sends this data to an agent server (1007). The process at the agent server sends a security portion to an access server (1008). The access server performs operations on the user security portion (1009). These operations include the following: detecting images that were chosen by the user, verifying that images are familiar to the user, verifying user answers to questions, comparing user biometrics with prototypes, contacting databases 1010 (to match user pictures, answers, biometrics etc.). After these operations 1009 are performed a rejection or acceptation is sent to the agent server (1011). The agent server either sends rejection to the user or performs a required service for the user (1012).

Given this disclosure alternative equivalent embodiments will become apparent to those skilled in the art. These embodiments are also within the contemplation of the inventors.

We claim:

1. A computer system comprising:
one or more central processing units (CPU), one or more memories, and one or more connections to a network;
a database stored on the memory that contains a plurality of sets of visual images, each set of visual images familiar to a user;
a process, executed by the CPU, that compares a selection of one or more selected image portions selected from an image having more than one image portion to the set of visual images familiar to the user and grants the user an access if one or more of the selected image portions matches one or more images in the set, the selected image portions being received over the connection.

2. A system, as in claim 1, where the access can be any one or more of the following: an access to financial information, an access to a financial account, an access to a secured location, an access to a computer account.

3. A system, as in claim 1, where the image portions are provided to the user by the computer system.

4. A system, as in claim 3, where one or more image portions provided are random images.

5. A system, as in claim 4, where the image portions include any one or more of the following: a person's image, a contour, a colorless contour, a picture of a place, a picture of an animal, a picture of professional tool, a picture of a recreational eqipment, a picture of a house, a picture of a building, a picture of a monument, a number that is related to the user, a composite of two or more images, a composite of two or more images that have an error, and an animation.

6. A system, as in claim 5, where numbers that are relevant to the user include any one or more of the following: a user street address, a user phone number, age of a user family member, and numbers from user professional activities.

7. A system, as in claim 4, where one or more of the image portions has an error.

8. A system, as in claim 7, where the error includes one or more of the following: an error in color, an error in feature, and an error in position.

9. A system, as in claim 4, where the user selects one or more of the following: the most familiar image portion and the least familiar image portion.

10. A system, as in claim 4, where the user selects an image portion that is relevant to user personal items.

11. A system, as in claim 10, where the user personal items include any one or more of the following: hobbies, professions, trips, music, books, movies, paintings, cooking.

12. A system, as in claim 10, where image portions relevant to the user personal items include one or more of the following: authors of books, authors of movies, authors of music, characters of books, actors, authors of paintings, food, drinks, and features of paintings.

13. A system, as in claim 1, where the selected image portion is selected by a marking pattern that is also received over the network connection and is required to match a stored marking pattern, stored in the database, before access is granted.

14. A system, as in claim 1, where one or more biometrics are also received over the network connection and each biometric is required to match one or more stored biometrics, stored in the database, before access is granted.

15. A system, as in claim 14, where the biometrics includes any one or more of the following: fingerprints, voice prints, a line crossing, a stressed mark, the following parameters of the crossing mark: height, width, and inclination.

16. A system, as in claim 1, where the image is preprinted on a document.

17. A system, as in claim 16, where the image, with the selected image portions is scanned to be sent over a network to the network connection.

18. A system, as in claim 1, where the image sent through the network connection over a network to be printed on a document.

19. A system, as in claim 18, where the image, with the selected image portions is scanned to be sent over a network to the network connection.

20. A system, as in claim 1, where one or more of the sets of visual images in the database is periodically updated.

21. A system, as in claim 1, where the image is a displayed image on one or more client computers connected to a network commonly connected to the network connection.

22. A system, as in claim 21, where the selected image portions are sent back over a network to the network connection.

23. A system, as in claim 1, where one or more answers to questions are also received over the network connection and each answer is required to match a stored answer, stored in the database, before access is granted.

24. A system, as in claim 1, where a process produces visual images to be stored in the database.

25. A system, as in claim 24, where visual images are familiar to the user and provided by the user.

26. A system, as in claim 25, where pictures provided by the user contain any one or more of the following: images of the user family members, images of the user house, images of the user city places, familiar locations, images of places that the user visited, images of objects related to the user activities, and images of the user's animals.

27. A system, as in claim 24, where visual images are not familiar to the user and are produced from sources that include: the Internet, books, cdroms, movies, and journals.

28. A system, as in claim in 24, where visual images are indexed with content labels describing their content.

29. A system, as in claim 28, where content labels characterize any one or more of the following: information: faces, buildings, professional tools, recreational equipment, city places, relevant to the user profession, relevant to the user hobbies, relevant to the user taste, familiar to the user, unfamiliar to the user, very familiar to the user, less familiar to the user, combination of image portions, error in an image portion including an error in a color, and an error in a feature.

30. A system, as in claim 24, where the database is updated periodically.

31. A system, as in claim 1, where a process combines familiar and not familiar images to be displayed to the user.

32. A system, as in claim 31, where errors are entered in images.

33. A system, as in claim 32, where errors are any one or more of the following: errors in features, errors in colors, and errors in combinations.

34. A system, as in claim 1, where the user is presented with visual images that are structured in accordance with security level.

35. A system, as in claim 34, where security level is higher if the user presented with any one or more of the following: a larger number of random images, a larger number of selections, and a larger number of questions.

36. A system, as in claim 24, where a process produces images with different security levels.

37. A system, as in claim 34, where a security level involves random questions that are answered in handwriting.

38. A system, as in claim 37, where biometrics from handwritings are used to verify a user identity.

39. A system, as in claim 1, where one or more processes are performed by several CPU at client and servers computers.

40. A system, as in claim 39, where a client is a computer that is accessed by a user, and other servers are one or more of the following: an agent server, an access server, that provides services.

41. A system, as in claim 39, where one or more processes perform the following procedures on a client computer: reads a request from a user, allows to a user to prepare a security portion, and sends the user data to an agent server.

42. A system, as in claim 41, where the agent server performs the following procedures: sends the user security portion to an access server, receives a rejection or acceptance from the access server, and sends to the user rejection or performs a service for the user on the service server.

43. A system, as in claim 42, where the access server performs the following procedures: identifies images crossed by the user, compares images with references, read user answers to questions, compares user answers with references, identifies degree of familiarity of images to the user, read user biometrics data, compares user biometrics with prototypes, contact user database to perform comparing of images, answers, and biometrics, send a rejection or acceptance to the agent server.
